(19) United States
(12) Patent Application Publication
(10) Pub. No.: US 2021/0272564 A1
(43) Pub. Date: Sep. 2, 2021

(54) VOICE PROCESSING DEVICE, VOICE PROCESSING METHOD, AND RECORDING MEDIUM

(71) Applicant: Sony Corporation, Tokyo (JP)

(72) Inventor: Chie KAMADA, Tokyo (JP)

(73) Assignee: Sony Corporation, Tokyo (JP)

(21) Appl. No.: 16/973,040

(22) PCT Filed: May 15, 2019
(86) PCT No.: PCT/JP2019/019356

§ 371 Date: Dec. 8, 2020

(30) Foreign Application Priority Data
Jun. 25, 2018 (JP) 2018-120264

(51) Int. Cl. G10L 15/22; G10L 15/30; G10L 17/24

(52) U.S. Cl. CPC G10L 15/22; G10L 2015/223; G10L 17/24; G10L 15/30

(57) ABSTRACT

To provide a voice processing device, a voice processing method, and a recording medium that can improve usability related to voice recognition. A voice processing device (1) includes a sound collecting unit (12) that collects voices and stores the collected voices in a voice storage unit (20), a detection unit (13) that detects a trigger for starting a predetermined function corresponding to the voice, and an execution unit (14) that controls, in a case in which a trigger is detected by the detection unit (13), execution of a predetermined function based on a voice collected before the trigger is detected.

### FIELD

The present disclosure relates to a voice processing device, a voice processing method, and a recording medium. Specifically, the present disclosure relates to voice recognition processing for an utterance received from a user.

### BACKGROUND

With widespread use of smartphones and smart speakers, voice recognition techniques for responding to an utterance received from a user have been widely used. In such voice recognition techniques, a wake word as a trigger for starting voice recognition is set in advance, and in a case in which it is determined that the user utters the wake word, voice recognition is started.

As a technique related to voice recognition, there is known a technique for dynamically setting a wake word to be uttered in accordance with a motion of a user to prevent user experience from being impaired due to utterance of the wake word.

### CITATION LIST

### Patent Literature

Patent Literature 1: Japanese Laid-open Patent Publication No. 2016-218852

### SUMMARY

### Technical Problem

However, there is room for improvement in the conventional technique described above. For example, in a case of performing voice recognition processing using the wake word, the user speaks to an appliance that controls voice recognition on the assumption that the user utters the wake word first. Thus, for example, in a case in which the user inputs a certain utterance while forgetting to say the wake word, voice recognition is not started, and the user should say the wake word and content of the utterance again. This fact causes the user to waste time and effort, and usability may be deteriorated.

Accordingly, the present disclosure provides a voice processing device, a voice processing method, and a recording medium that can improve usability related to voice recognition.

### Solution to Problem

To solve the above-described problem, a voice processing device according to the present disclosure comprises: a sound collecting unit configured to collect voices and store the collected voices in a voice storage unit; a detection unit configured to detect a trigger for starting a predetermined function corresponding to the voice; and an execution unit configured to control, in a case in which a trigger is detected by the detection unit, execution of the predetermined function based on a voice that is collected before the trigger is detected.

### Advantageous Effects of Invention

With the voice processing device, the voice processing method, and the recording medium according to the present disclosure, usability related to voice recognition can be improved. The effects described herein are not limitations, and any of the effects described herein may be employed.

### BRIEF DESCRIPTION OF DRAWINGS

FIG. 1 is a diagram illustrating an outline of information processing according to a first embodiment of the present disclosure.

FIG. 2 is a diagram illustrating a configuration example of a voice processing system according to the first embodiment of the present disclosure.

FIG. 3 is a flowchart illustrating a processing procedure according to the first embodiment of the present disclosure.

FIG. 4 is a diagram illustrating a configuration example of a voice processing system according to a second embodiment of the present disclosure.

FIG. 5 is a diagram illustrating an example of extracted utterance data according to the second embodiment of the present disclosure.

FIG. 6 is a flowchart illustrating a processing procedure according to the second embodiment of the present disclosure.

FIG. 7 is a diagram illustrating a configuration example of a voice processing system according to a third embodiment of the present disclosure.

FIG. 8 is a diagram illustrating a configuration example of a voice processing device according to a fourth embodiment of the present disclosure.

FIG. 9 is a hardware configuration diagram illustrating an example of a computer that implements a function of a smart speaker.

### DESCRIPTION OF EMBODIMENTS

The following describes embodiments of the present disclosure in detail based on the drawings. In the following embodiments, the same portion is denoted by the same reference numeral, and redundant description will not be repeated.

### 1. First Embodiment

### 1-1. Outline of Information Processing According to First Embodiment

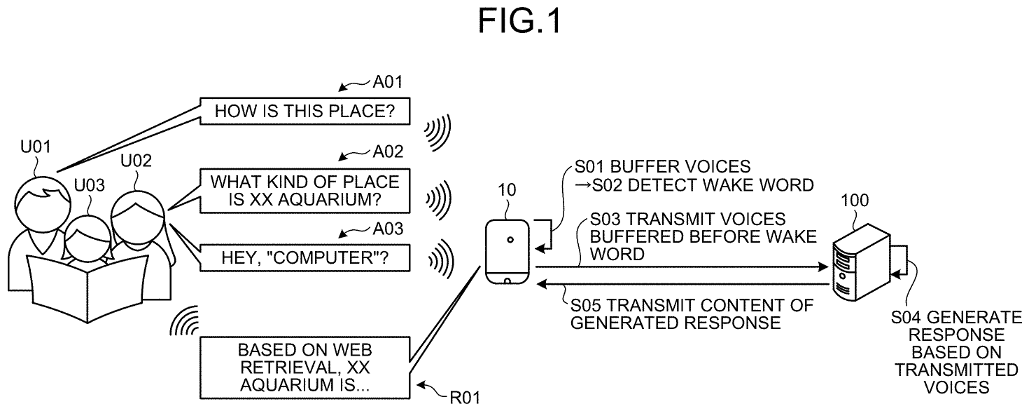

FIG. 1 is a diagram illustrating an outline of information processing according to a first embodiment of the present disclosure. The information processing according to the first embodiment of the present disclosure is performed by a voice processing system 1 illustrated in FIG. 1. As illustrated in FIG. 1, the voice processing system 1 includes a smart speaker 10 and an information processing server 100.

The smart speaker 10 is an example of a voice processing device according to the present disclosure. The smart speaker 10 is what is called an Internet of Things (IoT) appliance, and performs various kinds of information processing in cooperation with the information processing server 100. The smart speaker 10 may be called an agent appliance in some cases, for example. Voice recognition, response processing using a voice, and the like performed by the smart speaker 10 may be called an agent function in some cases. The agent appliance having the agent function is not limited to the smart speaker 10, and may be a smartphone, a tablet terminal, and the like. In this case, the smartphone and the tablet terminal execute a computer program (application) having the same function as that of the smart speaker 10 to exhibit the agent function described above.

In the first embodiment, the smart speaker 10 performs response processing for collected voices. For example, the smart speaker 10 recognizes a question from a user, and outputs an answer to the question by voice. In the example of FIG. 1, the smart speaker 10 is assumed to be installed in a house in which a user U01, a user U02, and a user U03, as examples of a user who uses the smart speaker 10, live. In the following description, in a case in which the user U01, the user U02, and the user U03 are not required to be distinguished from each other, the users are simply and collectively referred to as a “user”.

For example, the smart speaker 10 may include various sensors not only for collecting sounds generated in the house but also for acquiring other various kinds of information. For example, the smart speaker 10 may include a camera for acquiring space, an illuminance sensor that detects illuminance, a gyro sensor that detects inclination, an infrared sensor that detects an object, and the like in addition to a microphone.

The information processing server 100 illustrated in FIG. 1 is what is called a cloud server, which is a server device that performs information processing in cooperation with the smart speaker 10. The information processing server 100 acquires the voice collected by the smart speaker 10, analyzes the acquired voice, and generates a response corresponding to the analyzed voice. The information processing server 100 then transmits the generated response to the smart speaker 10. For example, the information processing server 100 generates a response to a question uttered by the user, or performs control processing for retrieving a tune requested by the user and causing the smart speaker 10 to output a retrieved voice. Various known techniques may be used for the response processing performed by the information processing server 100.

In a case of causing the agent appliance such as the smart speaker 10 to perform the voice recognition and the response processing as described above, the user is required to give a certain trigger to the agent appliance. For example, before uttering a request or a question, the user should give a certain trigger such as uttering a specific word for starting the agent function (hereinafter, referred to as a “wake word”), or gazing at a camera of the agent appliance. For example, when receiving a question from the user after the user utters the wake word, the smart speaker 10 outputs an answer to the question by voice. Due to this, the smart speaker 10 is not required to always transmit voices to the information processing server 100 or to perform arithmetic processing, so that a processing load can be reduced. The user can be prevented from falling into a situation in which an unnecessary answer is output from the smart speaker 10 when the user does not want a response.

However, the conventional processing described above may deteriorate usability in some cases. For example, in a case of making a certain request to the agent appliance, the user should carry out a procedure of interrupting a conversation with surrounding people that has been continued, uttering the wake word, and making a question thereafter. In a case in which the user forgot to say the wake word, the user should say the wake word and the entire sentence of the request again. In this way, in the conventional processing, the agent function cannot be flexibly used, and usability may be deteriorated.

Thus, the smart speaker 10 according to the present disclosure solves the problem of the related art by information processing described below. Specifically, even in a case in which the user utters the wake word after making an utterance of a request or a question, the smart speaker 10 is enabled to cope with the question or the request by going back to a voice that has been uttered by the user before the wake word. Due to this, the user is not required to say the wake word again even in a case in which the user forgot to say the wake word, so that the user can use the response processing performed by the smart speaker 10 without stress. The following describes an outline of information processing according to the present disclosure along a procedure with reference to FIG. 1.

As illustrated in FIG. 1, the smart speaker 10 collects daily conversations of the user U01, the user U02, and the user U03. At this point, the smart speaker 10 temporarily stores collected voices for a predetermined time (for example, 1 minute). That is, the smart speaker 10 buffers the collected voices, and repeatedly accumulates and deletes the voices corresponding to the predetermined time.

Additionally, the smart speaker 10 performs processing of detecting a trigger for starting a predetermined function corresponding to the voice while continuing the processing of collecting the voices. Specifically, the smart speaker 10 determines whether the collected voices include the wake word, and in a case in which it determines that the collected voices include the wake word, the smart speaker 10 detects the wake word. In the example of FIG. 1, the wake word set to the smart speaker 10 is assumed to be “computer”.

In the example illustrated in FIG. 1, the smart speaker 10 collects an utterance A01 of the user U01 such as “how is this place?” and an utterance A02 of the user U02 such as “what kind of place is XX aquarium?”, and buffers the collected voices (Step S01). Thereafter, the smart speaker 10 detects the wake word of “computer” from an utterance A03 of “hey, “computer” ?” uttered by the user U02 subsequent to the utterance A02 (Step S02).

The smart speaker 10 performs control for executing the predetermined function triggered by detection of the wake word of “computer”. In the example of FIG. 1, the smart speaker 10 transmits the utterance A01 and the utterance A02 as voices that are collected before the wake word is detected to the information processing server 100 (Step S03).

The information processing server 100 generates a response based on the transmitted voices (Step S04). Specifically, the information processing server 100 performs voice recognition on the transmitted utterance A01 and utterance A02, and performs semantic analysis based on text corresponding to each of the utterances. The information processing server 100 then generates a response suitable for analyzed meaning. In the example of FIG. 1, the information processing server 100 recognizes that the utterance A02 of “what kind of place is XX aquarium?” is a request for causing content (attribute) of “XX aquarium” to be retrieved, and performs Web retrieval for “XX aquarium”. The information processing server 100 then generates a response based on the retrieved content. Specifically, the information processing server 100 generates, as the response, voice data for outputting the retrieved content as a voice. The information processing server 100 then transmits the content of the generated response to the smart speaker 10 (Step S05).

The smart speaker 10 outputs, as a voice, the content received from the information processing server 100. Specifically, the smart speaker 10 outputs a response voice R01 including content such as “based on Web retrieval, XX aquarium is . . . ”.

In this way, the smart speaker 10 according to the first embodiment collects the voices, and stores (buffers) the collected voices in a voice storage unit. The smart speaker 10 also detects the trigger (wake word) for starting the predetermined function corresponding to the voice. In a case in which the trigger is detected, the smart speaker 10 controls execution of the predetermined function based on the voice that is collected before the trigger is detected. For example, the smart speaker 10 controls execution of the predetermined function corresponding to the voice (in the example of FIG. 1, a retrieval function for retrieving an object included in the voice) by transmitting the voice that is collected before the trigger is detected to the information processing server 100.

That is, in a case in which a voice recognition function is started by the wake word, the smart speaker 10 can make a response corresponding to the voice preceding the wake word by continuously buffering the voices. In other words, the smart speaker 10 does not require a voice input from the user U01 and others after the wake word is detected, and can perform response processing by tracing the buffered voices. Due to this, the smart speaker 10 can make an appropriate response to a casual question and the like uttered by the user U01 and others during a conversation without causing the user U01 and others to say the question again, so that usability related to the agent function can be improved.

### 1-2. Configuration of Voice Processing System According to First Embodiment

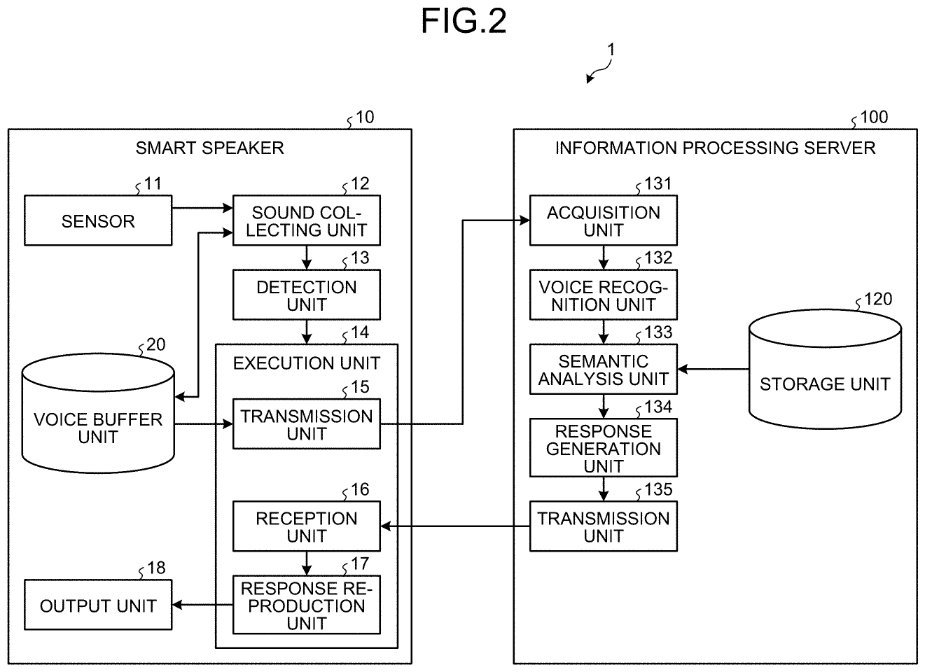

Next, the following describes a configuration of the voice processing system 1 including the information processing server 100 and the smart speaker 10 as an example of the voice processing device that performs information processing according to the first embodiment. FIG. 2 is a diagram illustrating a configuration example of the voice processing system 1 according to the first embodiment of the present disclosure. As illustrated in FIG. 2, the voice processing system 1 includes the smart speaker 10 and the information processing server 100.

As illustrated in FIG. 2, the smart speaker 10 includes processing units including a sound collecting unit 12, a detection unit 13, and an execution unit 14. The execution unit 14 includes a transmission unit 15, a reception unit 16, and a response reproduction unit 17. Each of the processing units is, for example, implemented when a computer program stored in the smart speaker 10 (for example, a voice processing program recorded in a recording medium according to the present disclosure) is executed by a central processing unit (CPU), a micro processing unit (MPU), and the like using a random access memory (RAM) and the like as a working area. Each of the processing units may be, for example, implemented by an integrated circuit such as an application specific integrated circuit (ASIC) and a field programmable gate array (FPGA).

The sound collecting unit 12 collects the voices by controlling a sensor 11 included in the smart speaker 10. The sensor 11 is, for example, a microphone. The sensor 11 may have a function of detecting various kinds of information related to a motion of the user such as orientation, inclination, movement, moving speed, and the like of a user's body. That is, the sensor 11 may be a camera that images the user or a peripheral environment, an infrared sensor that senses presence of the user, and the like.

The sound collecting unit 12 collects the voices, and stores the collected voices in the voice storage unit. Specifically, the sound collecting unit 12 temporarily stores the collected voices in a voice buffer unit 20 as an example of the voice storage unit. The voice buffer unit 20 is, for example, implemented by a semiconductor memory element such as a RAM and a flash memory, a storage device such as a hard disk and an optical disc, and the like.

The sound collecting unit 12 may previously receive a setting about an amount of information of the voices to be stored in the voice buffer unit 20. For example, the sound collecting unit 12 receives, from the user, a setting of storing the voices corresponding to a certain time as a buffer. The sound collecting unit 12 then receives the setting of the amount of information of the voices to be stored in the voice buffer unit 20, and stores the voices collected in a range of the received setting in the voice buffer unit 20. Due to this, the sound collecting unit 12 can buffer the voices in a range of storage capacity desired by the user.

In a case of receiving a request for deleting the voice stored in the voice buffer unit 20, the sound collecting unit 12 may delete the voice stored in the voice buffer unit 20. For example, the user may desire to prevent past voices from being stored in the smart speaker 10 in view of privacy in some cases. In this case, after receiving an operation related to deletion of the buffered voice from the user, the smart speaker 10 deletes the buffered voice.

The detection unit 13 detects the trigger for starting the predetermined function corresponding to the voice. Specifically, the detection unit 13 performs voice recognition on the voices collected by the sound collecting unit 12 as a trigger, and detects the wake word as a voice to be the trigger for starting the predetermined function. The predetermined function includes various functions such as voice recognition processing performed by the smart speaker 10, response generating processing performed by the information processing server 100, and voice output processing performed by the smart speaker 10.

In a case in which the trigger is detected by the detection unit 13, the execution unit 14 controls execution of the predetermined function based on the voice that is collected before the trigger is detected. As illustrated in FIG. 2, the execution unit 14 controls execution of the predetermined function based on processing performed by each of the processing units including the transmission unit 15, the reception unit 16, and the response reproduction unit 17.

The transmission unit 15 transmits various kinds of information via a wired or wireless network, and the like. For example, in a case in which the wake word is detected, the transmission unit 15 transmits, to the information processing server 100, the voices that are collected before the wake word is detected, that is, the voices buffered in the voice buffer unit 20. The transmission unit 15 may transmit, to the information processing server 100, not only the buffered voices but also the voices that are collected after the wake word is detected.

The reception unit 16 receives the response generated by the information processing server 100. For example, in a case in which the voice transmitted by the transmission unit 15 is related to the question, the reception unit 16 receives an answer generated by the information processing server 100 as the response. The reception unit 16 may receive either voice data or text data as the response.

The response reproduction unit 17 performs control for reproducing the response received by the reception unit 16. For example, the response reproduction unit 17 performs control to cause an output unit 18 (for example, a speaker) having a voice output function to output the response by voice. In a case in which the output unit 18 is a display, the response reproduction unit 17 may perform control processing for causing the received response to be displayed on the display as text data.

In a case in which the trigger is detected by the detection unit 13, the execution unit 14 may control execution of the predetermined function using the voices that are collected before the trigger is detected along with the voices that are collected after the trigger is detected.

Subsequently, the following describes the information processing server 100. As illustrated in FIG. 2, the information processing server 100 includes processing units including a storage unit 120, an acquisition unit 131, a voice recognition unit 132, a semantic analysis unit 133, a response generation unit 134, and a transmission unit 135.

The storage unit 120 is, for example, implemented by a semiconductor memory element such as a RAM and a flash memory, a storage device such as a hard disk and an optical disc, or the like. The storage unit 120 stores definition information and the like for responding to the voice acquired from the smart speaker 10. For example, the storage unit 120 stores various kinds of information such as a determination model for determining whether the voice is related to the question, an address of a retrieval server as a destination at which an answer for responding to the question is retrieved, and the like.

Each of the processing units such as the acquisition unit 131 is, for example, implemented when a computer program stored in the information processing server 100 is executed by a CPU, an MPU, and the like using a RAM and the like as a working area. Each of the processing units may also be implemented by an integrated circuit such as an ASIC and an FPGA, for example.

The acquisition unit 131 acquires the voices transmitted from the smart speaker 10. For example, in a case in which the wake word is detected by the smart speaker 10, the acquisition unit 131 acquires, from the smart speaker 10, the voices that are buffered before the wake word is detected. The acquisition unit 131 may also acquire, from the smart speaker 10, the voices that are uttered by the user after the wake word is detected in real time.

The voice recognition unit 132 converts the voices acquired by the acquisition unit 131 into character strings. The voice recognition unit 132 may also process the voices that are buffered before the wake word is detected and the voices that are acquired after the wake word is detected in parallel.

The semantic analysis unit 133 analyzes content of a request or a question from the user based on the character string recognized by the voice recognition unit 132. For example, the semantic analysis unit 133 refers to the storage unit 120, and analyzes the content of the request or the question meant by the character string based on the definition information and the like stored in the storage unit 120. Specifically, the semantic analysis unit 133 specifies the content of the request from the user such as “please tell me what a certain object is”, “please register a schedule in a calendar application”, and “please play a tune of a specific artist” based on the character string. The semantic analysis unit 133 then passes the specified content to the response generation unit 134.

For example, in the example of FIG. 1, the semantic analysis unit 133 analyzes an intention of the user U02 such as “I want to know what is XX aquarium” in accordance with a character string corresponding to the voice of “what kind of place is XX aquarium?” that is uttered by the user U02 before the wake word. That is, the semantic analysis unit 133 performs semantic analysis corresponding to the utterance before the user U02 utters the wake word. Due to this, the semantic analysis unit 133 can make a response following the intention of the user U02 without causing the user U02 to make the same question again after the user U02 utters “computer” as the wake word.

In a case in which the intention of the user cannot be analyzed based on the character string, the semantic analysis unit 133 may pass this fact to the response generation unit 134. For example, in a case in which information that cannot be estimated from the utterance of the user is included as a result of analysis, the semantic analysis unit 133 passes this content to the response generation unit 134. In this case, the response generation unit 134 may generate a response for requesting the user to accurately utter unclear information again.

The response generation unit 134 generates a response to the user in accordance with the content analyzed by the semantic analysis unit 133. For example, the response generation unit 134 acquires information corresponding to the analyzed content of the request, and generates content of a response such as wording to be the response. The response generation unit 134 may generate a response of “do nothing” to the utterance of the user depending on content of a question or a request. The response generation unit 134 passes the generated response to the transmission unit 135.

The transmission unit 135 transmits the response generated by the response generation unit 134 to the smart speaker 10. For example, the transmission unit 135 transmits, to the smart speaker 10, a character string (text data) and voice data generated by the response generation unit 134.

### 1-3. Information Processing Procedure According to First Embodiment

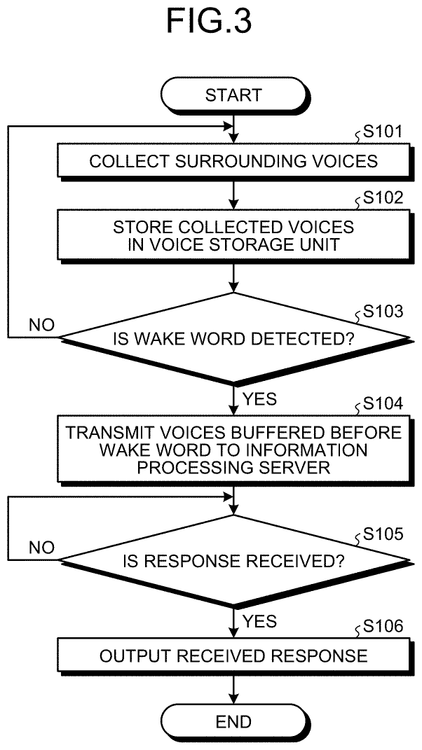

Next, the following describes an information processing procedure according to the first embodiment with reference to FIG. 3. FIG. 3 is a flowchart illustrating the processing procedure according to the first embodiment of the present disclosure. Specifically, with reference to FIG. 3, the following describes the processing procedure performed by the smart speaker 10 according to the first embodiment.

As illustrated in FIG. 3, the smart speaker 10 collects surrounding voices (Step S101). The smart speaker 10 then stores the collected voices in the voice storage unit (voice buffer unit 20) (Step S102). That is, the smart speaker 10 buffers the voices.

Thereafter, the smart speaker 10 determines whether the wake word is detected in the collected voices (Step S103). If the wake word is not detected (No at Step S103), the smart speaker 10 continues to collect the surrounding voices. On the other hand, if the wake word is detected (Yes at Step S103), the smart speaker 10 transmits the voices buffered before the wake word to the information processing server 100 (Step S104). The smart speaker 10 may also continue to transmit, to the information processing server 100, the voices that are collected after the buffered voices are transmitted to the information processing server 100.

Thereafter, the smart speaker 10 determines whether the response is received from the information processing server 100 (Step S105). If the response is not received (No at Step S105), the smart speaker 10 stands by until the response is received.

On the other hand, if the response is received (Yes at Step S105), the smart speaker 10 outputs the received response by voice and the like (Step S106).

### 1-4. Modification According to First Embodiment

In the first embodiment described above, described is an example in which the smart speaker 10 detects the wake word uttered by the user as the trigger. However, the trigger is not limited to the wake word.

For example, in a case in which the smart speaker 10 includes a camera as the sensor 11, the smart speaker 10 may perform image recognition on an image obtained by imaging the user, and detect the trigger from the recognized information. By way of example, the smart speaker 10 may detect a line of sight of the user gazing at the smart speaker 10. In this case, the smart speaker 10 may determine whether the user is gazing at the smart speaker 10 by using various known techniques related to detection of a line of sight.

In a case of determining that the user is gazing at the smart speaker 10, the smart speaker 10 determines that the user desires a response from the smart speaker 10, and transmits the buffered voices to the information processing server 100. Through such processing, the smart speaker 10 can make a response based on the voice that is uttered by the user before the user turn his/her eyes thereto. In this way, the smart speaker 10 can perform processing while grasping the intention of the user before the user utters the wake word by performing response processing in accordance with the line of sight of the user, so that usability can be further improved.

In a case in which the smart speaker 10 includes an infrared sensor and the like as the sensor 11, the smart speaker 10 may detect information obtained by sensing a predetermined motion of the user or a distance to the user as the trigger. For example, the smart speaker 10 may sense that the user approaches a range of a predetermined distance from the smart speaker 10 (for example, 1 meter), and detect the approaching motion as the trigger for voice response processing. Alternatively, the smart speaker 10 may detect the fact that the user approaches the smart speaker 10 from the outside of the range of the predetermined distance and faces the smart speaker 10, for example. In this case, the smart speaker 10 may determine that the user approaches the smart speaker 10 or the user faces the smart speaker 10 by using various known techniques related to detection of the motion of the user.

The smart speaker 10 then senses a predetermined motion of the user or a distance to the user, and in a case in which the sensed information satisfies a predetermined condition, determines that the user desires a response from the smart speaker 10, and transmits the buffered voices to the information processing server 100. Through such processing, the smart speaker 10 can make a response based on the voice that is uttered before the user performs the predetermined motion and the like. In this way, the smart speaker 10 can further improve usability by performing response processing while estimating that the user desires a response based on the motion of the user.

### 2. Second Embodiment

### 2-1. Configuration of Voice Processing System According to Second Embodiment

Next, the following describes a second embodiment. Specifically, the following describes processing of extracting only the utterances to be buffered at the time when a smart speaker 10A according to the second embodiment buffers the collected voices.

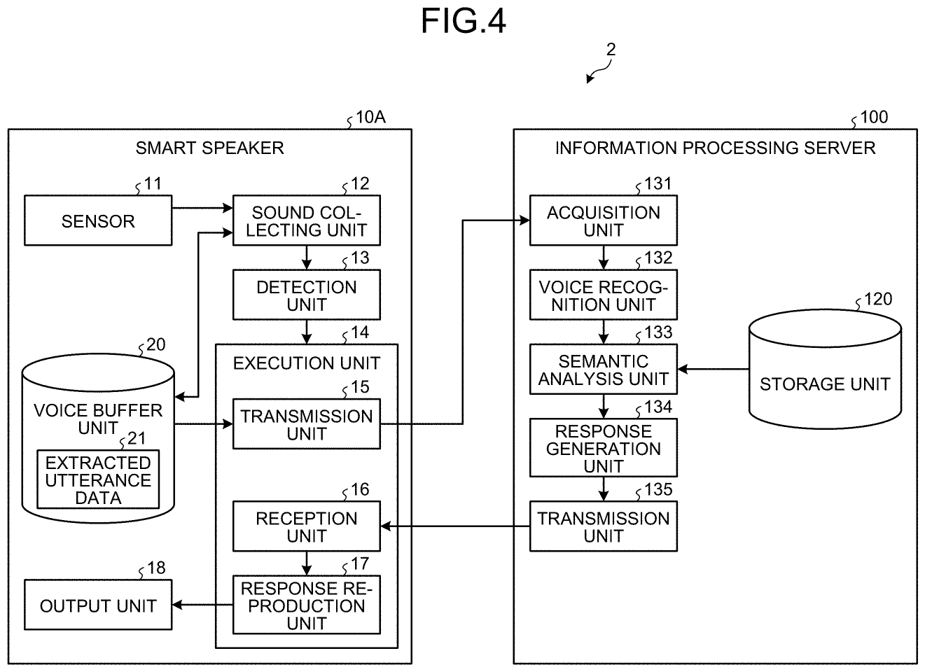

FIG. 4 is a diagram illustrating a configuration example of a voice processing system 2 according to the second embodiment of the present disclosure. As illustrated in FIG. 4, the smart speaker 10A according to the second embodiment further includes extracted utterance data 21 as compared with the first embodiment. Description about the same configuration as that of the smart speaker 10 according to the first embodiment will not be repeated.

The extracted utterance data 21 is a database obtained by extracting only voices that are estimated to be the voices related to the utterances of the user among the voices buffered in the voice buffer unit 20. That is, the sound collecting unit 12 according to the second embodiment collects the voices, extracts the utterances from the collected voices, and stores the extracted utterances in the extracted utterance data 21 in the voice buffer unit 20. The sound collecting unit 12 may extract the utterances from the collected voices using various known techniques such as voice section detection, speaker specifying processing, and the like.

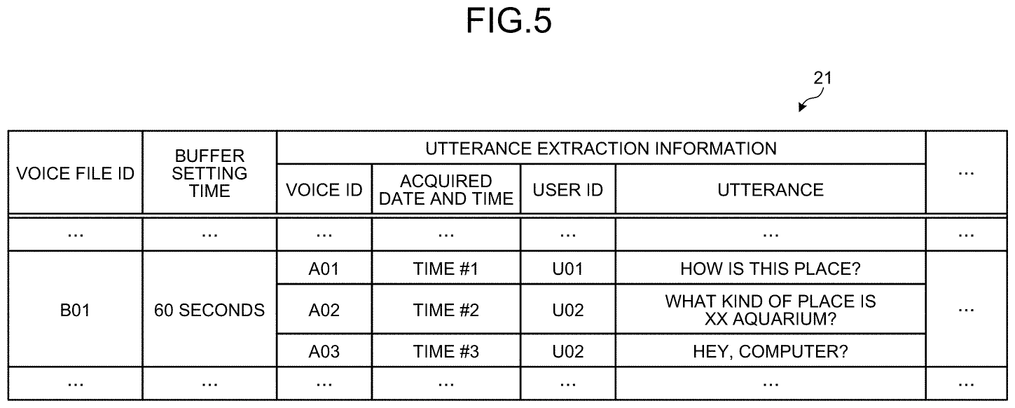

FIG. 5 illustrates an example of the extracted utterance data 21 according to the second embodiment. FIG. 5 is a diagram illustrating an example of the extracted utterance data 21 according to the second embodiment of the present disclosure. In the example illustrated in FIG. 5, the extracted utterance data 21 includes items such as “voice file ID”, “buffer setting time”, “utterance extraction information”, “voice ID”, “acquired date and time”, “user ID”, and “utterance”.

“Voice file ID” indicates identification information for identifying a voice file of the buffered voice. “Buffer setting time” indicates a time length of the voice to be buffered. “Utterance extraction information” indicates information about the utterance extracted from the buffered voice. “Voice ID” indicates identification information for identifying the voice (utterance). “Acquired date and time” indicates the date and time when the voice is acquired. “User ID” indicates identification information for identifying the user who made the utterance. In a case in which the user who made the utterance cannot be specified, the smart speaker 10A does not necessarily register the information about the user ID. “Utterance” indicates specific content of the utterance. FIG. 5 illustrates an example in which a specific character string is stored as the item of the utterance for explanation, but voice data related to the utterance or time data for specifying the utterance (information indicating a start point and an end point of the utterance) may be stored as the item of the utterance.

In this way, the smart speaker 10A according to the second embodiment may extract and store only the utterances from the buffered voices. Due to this, the smart speaker 10A can buffer only the voices required for response processing, and may delete the other voices or omit transmission of the voices to the information processing server 100, so that a processing load can be reduced. By previously extracting the utterance and transmitting the voice to the information processing server 100, the smart speaker 10A can reduce a burden on the processing performed by the information processing server 100.

By storing the information obtained by identifying the user who made the utterance, the smart speaker 10A can also determine whether the buffered utterance matches the user who made the wake word.

In this case, in a case in which the wake word is detected by the detection unit 13, the execution unit 14 may extract the utterance of a user same as the user who uttered the wake word from the utterances stored in the extracted utterance data 21, and control execution of the predetermined function based on the extracted utterance. For example, the execution unit 14 may extract only the utterances made by the user same as the user who uttered the wake word from the buffered voices, and transmit the utterances to the information processing server 100.

For example, in a case of making a response using the buffered voice, when an utterance other than that of the user who uttered the wake word is used, a response unintended by the user who actually uttered the wake word may be made. Thus, by transmitting only the utterances of the user same as the user who uttered the wake word among the buffered voices to the information processing server 100, the execution unit 14 can cause an appropriate response desired by the user to be generated.

The execution unit 14 is not necessarily required to transmit only the utterances made by the user same as the user who uttered the wake word. That is, in a case in which the wake word is detected by the detection unit 13, the execution unit 14 may extract the utterance of the user same as the user who uttered the wake word and an utterance of a predetermined user registered in advance from the utterances stored in the extracted utterance data 21, and control execution of the predetermined function based on the extracted utterance.

For example, the agent appliance such as the smart speaker 10A has a function of previously registering users such as family in some cases. In a case of having such a function, the smart speaker 10A may transmit the utterance to the information processing server 100 at the time of detecting the wake word even when the utterance is made by a user different from the user who uttered the wake word so long as the utterance is made by a user registered in advance. In the example of FIG. 5, when the user U01 is a user registered in advance, in a case in which the user U02 utters the wake word of “computer”, the smart speaker 10A may transmit not only the utterance of the user U02 but also the utterance of the user U01 to the information processing server 100.

### 2-2. Information Processing Procedure According to Second Embodiment

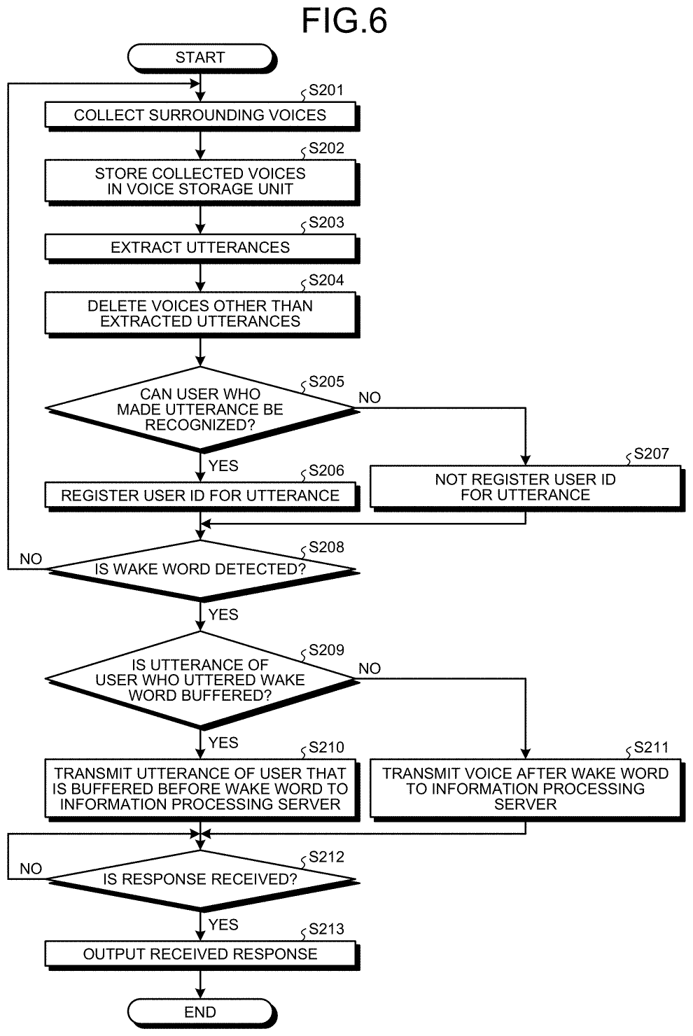

Next, the following describes an information processing procedure according to the second embodiment with reference to FIG. 6. FIG. 6 is a flowchart illustrating the processing procedure according to the first embodiment of the present disclosure. Specifically, with reference to FIG. 6, the following describes the processing procedure performed by the smart speaker 10A according to the first embodiment.

As illustrated in FIG. 6, the smart speaker 10A collects surrounding voices (Step S201). The smart speaker 10A then stores the collected voices in the voice storage unit (voice buffer unit 20) (Step S202).

Additionally, the smart speaker 10A extracts utterances from the buffered voices (Step S203). The smart speaker 10A then deletes the voices other than the extracted utterances (Step S204). Due to this, the smart speaker 10A can appropriately secure storage capacity for buffering.

Furthermore, the smart speaker 10A determines whether the user who made the utterance can be recognized (Step S205). For example, the smart speaker 10A identifies the user who uttered the voice based on a user recognition model generated at the time of registering the user to recognize the user who made the utterance.

If the user who made the utterance can be recognized (Yes at Step S205), the smart speaker 10A registers the user ID for the utterance in the extracted utterance data 21 (Step S206). On the other hand, if the user who made the utterance cannot be recognized (No at Step S205), the smart speaker 10A does not register the user ID for the utterance in the extracted utterance data 21 (Step S207).

Thereafter, the smart speaker 10A determines whether the wake word is detected in the collected voices (Step S208). If the wake word is not detected (No at Step S208), the smart speaker 10A continues to collect the surrounding voices.

On the other hand, if the wake word is detected (Yes at Step S208), the smart speaker 10A determines whether the utterance of the user who uttered the wake word (or the utterance of the user registered in the smart speaker 10A) is buffered (Step S209). If the utterance of the user who uttered the wake word is buffered (Yes at Step S209), the smart speaker 10A transmits, to the information processing server 100, the utterance of the user that is buffered before the wake word (Step S210).

On the other hand, if the utterance of the user who uttered the wake word is not buffered (No at Step S210), the smart speaker 10A does not transmit the voice that is buffered before the wake word, and transmits the voice collected after the wake word to the information processing server 100 (Step S211). Due to this, the smart speaker 10A can prevent a response from being generated based on a voice uttered in the past by a user other than the user who uttered the wake word.

Thereafter, the smart speaker 10A determines whether the response is received from the information processing server 100 (Step S212). If the response is not received (No at Step S212), the smart speaker 10A stands by until the response is received.

On the other hand, if the response is received (Yes at Step S212), the smart speaker 10A outputs the received response by voice and the like (Step S213).

### 3. Third Embodiment

Next, the following describes a third embodiment. Specifically, the following describes processing of making a predetermined notification to the user performed by a smart speaker 10B according to the third embodiment.

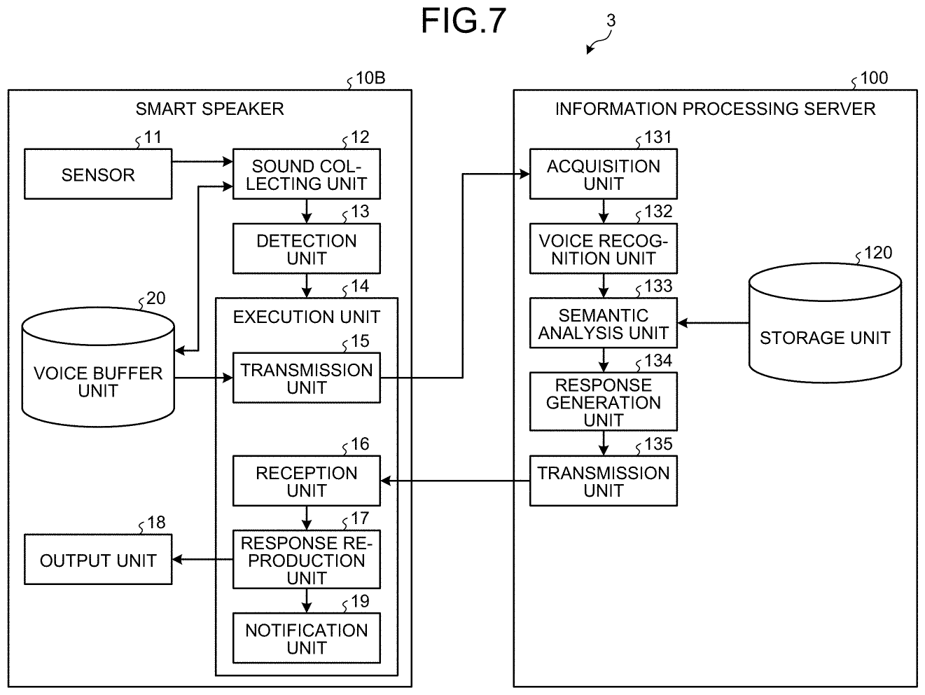

FIG. 7 is a diagram illustrating a configuration example of a voice processing system 3 according to the third embodiment of the present disclosure. As illustrated in FIG. 7, the smart speaker 10B according to the third embodiment further includes a notification unit 19 as compared with the first embodiment. Description about the same components as that of the smart speaker 10 according to the first embodiment and that of the smart speaker 10A according to the second embodiment will not be repeated.

In a case in which the execution unit 14 controls execution of the predetermined function using the voice that is collected before the trigger is detected, the notification unit 19 make a notification to the user.

As described above, the smart speaker 10B and the information processing server 100 according to the present disclosure perform response processing based on the buffered voices. Such processing is performed based on the voice uttered before the wake word, so that the user can be prevented from taking excess time and effort. However, the user may be made anxious about how long ago the voice based on which the processing is performed was uttered. That is, the voice response processing using the buffer may make the user be anxious about whether privacy is invaded because living sounds are collected at all times. That is, such a technique has the problem that anxiety of the user should be reduced. On the other hand, the smart speaker 10B can give a sense of security to the user by making a predetermined notification to the user through notification processing performed by the notification unit 19.

For example, at the time when the predetermined function is executed, the notification unit 19 makes a notification in different modes between a case of using the voice collected before the trigger is detected and a case of using the voice collected after the trigger is detected. By way of example, in a case in which the response processing is performed by using the buffered voice, the notification unit 19 performs control so that red light is emitted from an outer surface of the smart speaker 10B. In a case in which the response processing is performed by using the voice after the wake word, the notification unit 19 performs control so that blue light is emitted from the outer surface of the smart speaker 10B. Due to this, the user can recognize whether the response to himself/herself is made based on the buffered voice, or based on the voice that is uttered by himself/herself after the wake word.

The notification unit 19 may make a notification in a further different mode. Specifically, in a case in which the voice collected before the trigger is detected is used at the time when the predetermined function is executed, the notification unit 19 may notify the user of a log corresponding to the used voice. For example, the notification unit 19 may convert the voice that is actually used for the response into a character string to be displayed on an external display included in the smart speaker 10B. With reference to FIG. 1 as an example, the notification unit 19 displays a character string of “Where is XX aquarium?” on the external display, and outputs the response voice R01 together with that display. Due to this, the user can accurately recognize which utterance is used for the processing, so that the user can acquire a sense of security in view of privacy protection.

The notification unit 19 may display the character string used for the response via a predetermined device instead of displaying the character string on the smart speaker 10B. For example, in a case in which the buffered voice is used for processing, the notification unit 19 may transmit a character string corresponding to the voice used for processing to a terminal such as a smartphone registered in advance. Due to this, the user can accurately grasp which voice is used for the processing and which character string is not used for the processing.

The notification unit 19 may also make a notification indicating whether the buffered voice is transmitted. For example, in a case in which the trigger is not detected and the voice is not transmitted, the notification unit 19 performs control to output display indicating that fact (for example, to output light of blue color). On the other hand, in a case in which the trigger is detected, the buffered voice is transmitted, and the voice subsequent thereto is used for executing the predetermined function, the notification unit 19 performs control to output display indicating that fact (for example, to output light of red color).

The notification unit 19 may also receive feedback from the user who receives the notification. For example, after making the notification that the buffered voice is used, the notification unit 19 receives, from the user, a voice suggesting using a further previous utterance such as “no, use older utterance”. In this case, for example, the execution unit 14 may perform predetermined learning processing such as prolonging a buffer time, or increasing the number of utterances to be transmitted to the information processing server 100. That is, the execution unit 14 may adjust an amount of information of the voice that is collected before the trigger is detected and used for executing the predetermined function based on a reaction of the user to execution of the predetermined function. Due to this, the smart speaker 10B can perform response processing more adapted to a use mode of the user.

### 4. Fourth Embodiment

Next, the following describes a fourth embodiment. From the first embodiment to the third embodiment, the information processing server 100 generates the response. However, a smart speaker 10C as an example of the voice processing device according to the fourth embodiment generates a response by itself.

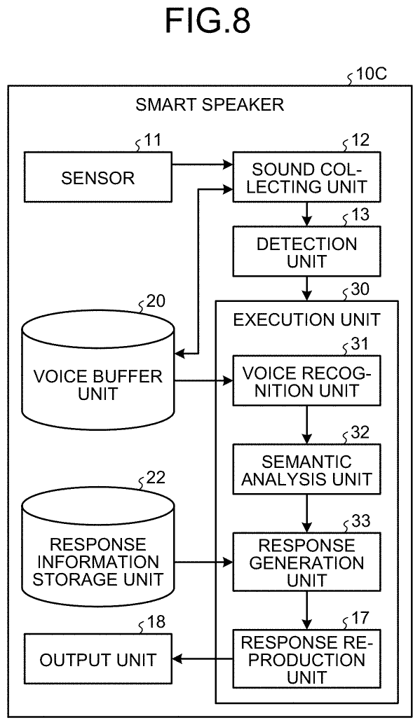

FIG. 8 is a diagram illustrating a configuration example of the voice processing device according to the fourth embodiment of the present disclosure. As illustrated in FIG. 8, the smart speaker 10C as an example of the voice processing device according to the fourth embodiment includes an execution unit 30 and a response information storage unit 22.

The execution unit 30 includes a voice recognition unit 31, a semantic analysis unit 32, a response generation unit 33, and the response reproduction unit 17. The voice recognition unit 31 corresponds to the voice recognition unit 132 described in the first embodiment. The semantic analysis unit 32 corresponds to the semantic analysis unit 133 described in the first embodiment. The response generation unit 33 corresponds to the response generation unit 134 described in the first embodiment. The response information storage unit 22 corresponds to the storage unit 120.

The smart speaker 10C performs response generating processing, which is performed by the information processing server 100 according to the first embodiment, by itself. That is, the smart speaker 10C performs information processing according to the present disclosure on a stand-alone basis without using an external server device and the like. Due to this, the smart speaker 10C according to the fourth embodiment can implement information processing according to the present disclosure with a simple system configuration.

### 5. Other Embodiments

The processing according to the respective embodiments described above may be performed in various different forms other than the embodiments described above.

For example, the voice processing device according to the present disclosure may be implemented as a function of a smartphone and the like instead of a stand-alone appliance such as the smart speaker 10. The voice processing device according to the present disclosure may also be implemented in a mode of an IC chip and the like mounted in an information processing terminal.

Among pieces of the processing described above in the respective embodiments, all or part of the pieces of processing described to be automatically performed can also be manually performed, or all or part of the pieces of processing described to be manually performed can also be automatically performed using a well-known method. Additionally, information including processing procedures, specific names, various kinds of data, and parameters that are described herein and illustrated in the drawings can be optionally changed unless otherwise specifically noted. For example, various kinds of information illustrated in the drawings are not limited to the information illustrated therein.

The components of the devices illustrated in the drawings are merely conceptual, and it is not required that the components be physically configured as illustrated necessarily. That is, specific forms of distribution and integration of the devices are not limited to those illustrated in the drawings. All or part thereof may be functionally or physically distributed/integrated in arbitrary units depending on various loads or usage states. For example, the reception unit 16 and the response reproduction unit 17 illustrated in FIG. 2 may be integrated with each other.

The embodiments and the modifications described above can be combined as appropriate without contradiction of processing content.

The effects described herein are merely examples, and the effects are not limited thereto. Other effects may be exhibited.

### 6. Hardware Configuration

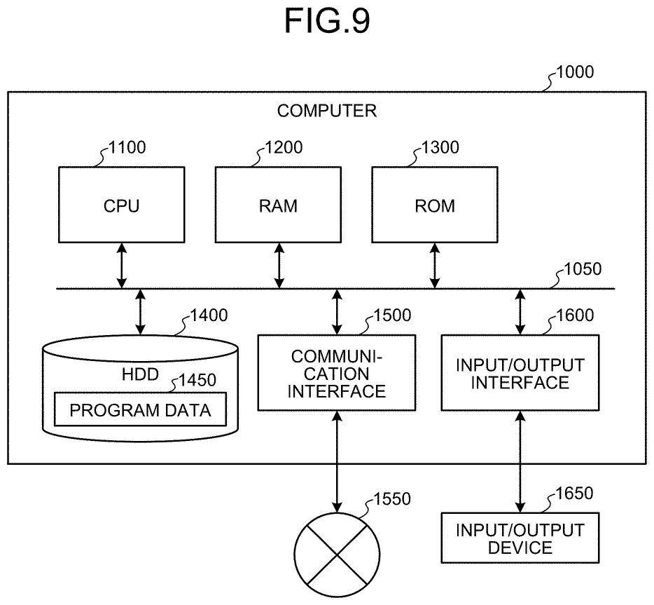

The information device such as the information processing server 100 or the smart speaker 10 according to the embodiments described above is implemented by a computer 1000 having a configuration illustrated in FIG. 9, for example. The following exemplifies the smart speaker 10 according to the first embodiment. FIG. 9 is a hardware configuration diagram illustrating an example of the computer 1000 that implements the function of the smart speaker 10. The computer 1000 includes a CPU 1100, a RAM 1200, a read only memory (ROM) 1300, a hard disk drive (HDD) 1400, a communication interface 1500, and an input/output interface 1600. Respective parts of the computer 1000 are connected to each other via a bus 1050.

The CPU 1100 operates based on a computer program stored in the ROM 1300 or the HDD 1400, and controls the respective parts. For example, the CPU 1100 loads the computer program stored in the ROM 1300 or the HDD 1400 into the RAM 1200, and performs processing corresponding to various computer programs.

The ROM 1300 stores a boot program such as a Basic Input Output System (BIOS) executed by the CPU 1100 at the time when the computer 1000 is started, a computer program depending on hardware of the computer 1000, and the like.

The HDD 1400 is a computer-readable recording medium that non-temporarily records a computer program executed by the CPU 1100, data used by the computer program, and the like. Specifically, the HDD 1400 is a recording medium that records the voice processing program according to the present disclosure as an example of program data 1450.

The communication interface 1500 is an interface for connecting the computer 1000 with an external network 1550 (for example, the Internet). For example, the CPU 1100 receives data from another appliance, or transmits data generated by the CPU 1100 to another appliance via the communication interface 1500.

The input/output interface 1600 is an interface for connecting an input/output device 1650 with the computer 1000. For example, the CPU 1100 receives data from an input device such as a keyboard and a mouse via the input/output interface 1600. The CPU 1100 transmits data to an output device such as a display, a speaker, and a printer via the input/output interface 1600. The input/output interface 1600 may function as a media interface that reads a computer program and the like recorded in a predetermined recording medium (media). Examples of the media include an optical recording medium such as a Digital Versatile Disc (DVD) and a Phase change rewritable Disk (PD), a Magneto-Optical recording medium such as a Magneto-Optical disk (MO), a tape medium, a magnetic recording medium, a semiconductor memory, or the like.

For example, in a case in which the computer 1000 functions as the smart speaker 10 according to the first embodiment, the CPU 1100 of the computer 1000 executes the voice processing program loaded into the RAM 1200 to implement the function of the sound collecting unit 12 and the like. The HDD 1400 stores the voice processing program according to the present disclosure, and the data in the voice buffer unit 20. The CPU 1100 reads the program data 1450 from the HDD 1400 to be executed. Alternatively, as another example, the CPU 1100 may acquire these computer programs from another device via the external network 1550.

The present technique can employ the following configurations.

(1) A voice processing device comprising:

a sound collecting unit configured to collect voices and store the collected voices in a voice storage unit;

a detection unit configured to detect a trigger for starting a predetermined function corresponding to the voice; and

an execution unit configured to control, in a case in which a trigger is detected by the detection unit, execution of the predetermined function based on a voice that is collected before the trigger is detected.

(2) The voice processing device according to the (1), wherein the detection unit performs voice recognition on the voices collected by the sound collecting unit as the trigger, and detects a wake word as a voice to be the trigger for starting the predetermined function.
(3) The voice processing device according to the (1) or (2), wherein the sound collection unit extracts utterances from the collected voices, and stores the extracted utterances in the voice storage unit.
(4) The voice processing device according to the (3), wherein the execution unit extracts, in a case in which the wake word is detected by the detection unit, an utterance of s user same as the user who uttered the wake word from the utterances stored in the voice storage unit, and controls execution of the predetermined function based on the extracted utterance.
(5) The voice processing device according to the (4), wherein the execution unit extracts, in a case in which the wake word is detected by the detection unit, the utterance of the user same as the user who uttered the wake word and an utterance of a predetermined user registered in advance from the utterances stored in the voice storage unit, and controls execution of the predetermined function based on the extracted utterance.
(6) The voice processing device according to any one of the (1) to (5), wherein the sound collecting unit receives a setting about an amount of information of the voices to be stored in the voice storage unit, and stores voices that are collected in a range of the received setting in the voice storage unit.
(7) The voice processing device according to any one of the (1) to (6), wherein the sound collecting unit deletes the voice stored in the voice storage unit in a case of receiving a request for deleting the voice stored in the voice storage unit.
(8) The voice processing device according to any one of the (1) to (7), further comprising:

a notification unit configured to make a notification to a user in a case in which execution of the predetermined function is controlled by the execution unit using a voice collected before the trigger is detected.

(9) The voice processing device according to the (8), wherein the notification unit makes a notification in different modes between a case of using a voice collected before the trigger is detected and a case of using a voice collected after the trigger is detected.
(10) The voice processing device according to the (8) or (9), wherein, in a case in which a voice collected before the trigger is detected is used, the notification unit notifies the user of a log corresponding to the used voice.
(11) The voice processing device according to any one of the (1) to (10), wherein, in a case in which a trigger is detected by the detection unit, the execution unit controls execution of the predetermined function using a voice collected before the trigger is detected and a voice collected after the trigger is detected.
(12) The voice processing device according to any one of the (1) to (11), wherein the execution unit adjusts an amount of information of the voice that is collected before the trigger is detected and used for executing the predetermined function based on a reaction of the user to execution of the predetermined function.
(13) The voice processing device according to any one of the (1) to (12), wherein the detection unit performs image recognition on an image obtained by imaging a user as the trigger, and detects a gazing line of sight of the user.
(14) The voice processing device according to any one of the (1) to (13), wherein the detection unit detects information obtained by sensing a predetermined motion of a user or a distance to the user as the trigger.
(15) A voice processing method performed by a computer, the voice processing method comprising:

collecting voices, and storing the collected voices in a voice storage unit;

detecting a trigger for starting a predetermined function corresponding to the voice; and controlling, in a case in which the trigger is detected, execution of the predetermined function based on a voice collected before the trigger is detected.

(16) A computer-readable non-transitory recording medium recording a voice processing program for causing a computer to function as:

a sound collecting unit configured to collect voices and store the collected voices in a voice storage unit;

a detection unit configured to detect a trigger for starting a predetermined function corresponding to the voice; and

an execution unit configured to control, in a case in which a trigger is detected by the detection unit, execution of the predetermined function based on a voice that is collected before the trigger is detected.

### REFERENCE SIGNS LIST

1, 2, 3 VOICE PROCESSING SYSTEM
10, 10A, 10B, 10C SMART SPEAKER
100 INFORMATION PROCESSING SERVER
12 SOUND COLLECTING UNIT
13 DETECTION UNIT
14, 30 EXECUTION UNIT
15 TRANSMISSION UNIT
16 RECEPTION UNIT
17 RESPONSE REPRODUCTION UNIT
18 OUTPUT UNIT
19 NOTIFICATION UNIT
20 VOICE BUFFER UNIT
21 EXTRACTED UTTERANCE DATA
22 RESPONSE INFORMATION STORAGE UNIT

1. A voice processing device comprising:
a sound collecting unit configured to collect voices and store the collected voices in a voice storage unit;
a detection unit configured to detect a trigger for starting a predetermined function corresponding to the voice; and
an execution unit configured to control, in a case in which a trigger is detected by the detection unit, execution of the predetermined function based on a voice that is collected before the trigger is detected.

2. The voice processing device according to claim 1, wherein the detection unit performs voice recognition on the voices collected by the sound collecting unit as the trigger, and detects a wake word as a voice to be the trigger for starting the predetermined function.

3. The voice processing device according to claim 1, wherein the sound collection unit extracts utterances from the collected voices, and stores the extracted utterances in the voice storage unit.

4. The voice processing device according to claim 3, wherein the execution unit extracts, in a case in which the wake word is detected by the detection unit, an utterance of s user same as the user who uttered the wake word from the utterances stored in the voice storage unit, and controls execution of the predetermined function based on the extracted utterance.

5. The voice processing device according to claim 4, wherein the execution unit extracts, in a case in which the wake word is detected by the detection unit, the utterance of the user same as the user who uttered the wake word and an utterance of a predetermined user registered in advance from the utterances stored in the voice storage unit, and controls execution of the predetermined function based on the extracted utterance.

6. The voice processing device according to claim 1, wherein the sound collecting unit receives a setting about an amount of information of the voices to be stored in the voice storage unit, and stores voices that are collected in a range of the received setting in the voice storage unit.

7. The voice processing device according to claim 1, wherein the sound collecting unit deletes the voice stored in the voice storage unit in a case of receiving a request for deleting the voice stored in the voice storage unit.

8. The voice processing device according to claim 1, further comprising:
a notification unit configured to make a notification to a user in a case in which execution of the predetermined function is controlled by the execution unit using a voice collected before the trigger is detected.

9. The voice processing device according to claim 8, wherein the notification unit makes a notification in different modes between a case of using a voice collected before the trigger is detected and a case of using a voice collected after the trigger is detected.

10. The voice processing device according to claim 8, wherein, in a case in which a voice collected before the trigger is detected is used, the notification unit notifies the user of a log corresponding to the used voice.

11. The voice processing device according to claim 1, wherein, in a case in which a trigger is detected by the detection unit, the execution unit controls execution of the predetermined function using a voice collected before the trigger is detected and a voice collected after the trigger is detected.

12. The voice processing device according to claim 1, wherein the execution unit adjusts an amount of information of the voice that is collected before the trigger is detected and used for executing the predetermined function based on a reaction of the user to execution of the predetermined function.

13. The voice processing device according to claim 1, wherein the detection unit performs image recognition on an image obtained by imaging a user as the trigger, and detects a gazing line of sight of the user.

14. The voice processing device according to claim 1, wherein the detection unit detects information obtained by sensing a predetermined motion of a user or a distance to the user as the trigger.

15. A voice processing method performed by a computer, the voice processing method comprising:
collecting voices, and storing the collected voices in a voice storage unit;
detecting a trigger for starting a predetermined function corresponding to the voice; and
controlling, in a case in which the trigger is detected, execution of the predetermined function based on a voice collected before the trigger is detected.

16. A computer-readable non-transitory recording medium recording a voice processing program for causing a computer to function as:
a sound collecting unit configured to collect voices and store the collected voices in a voice storage unit;
a detection unit configured to detect a trigger for starting a predetermined function corresponding to the voice; and
an execution unit configured to control, in a case in which a trigger is detected by the detection unit, execution of the predetermined function based on a voice that is collected before the trigger is detected.
